(19) United States
(12) Patent Application Publication
(10) Pub. No.: US 2026/0257236 A1
(43) Pub. Date: Sep. 3, 2026

(54) SYSTEM AND METHOD FOR AN AGRICULTURAL APPLICATOR

(71) Applicants: CNH Industrial America LLC, New Holland, PA (US); Kansas State University Research Foundation, Manhattan, KS (US)

(72) Inventors: Ajay Sharda, Manhattan, KS (US); Jonathan Fabula, Manhattan, KS (US)

(21) Appl. No.: 19/066,834

(22) Filed: Feb. 28, 2025

(51) Int. Cl. B05B 12/12; A01C 23/04; A01M 7/00; B05B 1/20; B05B 12/00

(52) U.S. Cl. CPC B05B 12/12; A01C 23/047; A01M 7/006; B05B 1/20; B05B 12/006; A01M 7/0085

(57) ABSTRACT

An agricultural system may include a boom assembly including a frame and a boom arm. A nozzle assembly may be positioned along the boom assembly. The agricultural system may include a first position sensor and a second position sensor separated from the first position. A computing system may be communicatively coupled to the first position sensor and the second position sensor. The computing system may be configured to receive, from the first position sensor, data associated with a first position of the first position sensor, receive, from the second position sensor, data associated with a second position of the second position sensor, determine a speed difference between the first position sensor and the second position sensor, and extrapolate the speed difference to determine a nozzle characteristic based on the speed difference.

### FIELD

The present disclosure generally relates to agricultural implements and, more particularly, to systems and methods for monitoring a spray operation.

### BACKGROUND

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled and may include a tank, a pump, a boom assembly, and a plurality of nozzles carried by the boom assembly at spaced locations. The boom assembly may include a pair of boom arms, with each boom arm extending to either side of the applicator when in an unfolded state. Each boom arm may include multiple boom sections, each with a number of spray nozzles (also sometimes referred to as spray tips).

The spray nozzles on the boom assembly disperse the agricultural product carried by the applicator onto a field. During a spray operation, however, various factors may affect a quality of application of the agricultural product to the field. Accordingly, an improved system and method for monitoring the quality of application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system that includes a boom assembly including a frame and a boom arm. A nozzle assembly is positioned along the boom assembly. The agricultural system also includes a first position sensor and a second position sensor separated from the first position. A computing system is communicatively coupled to the first position sensor and the second position sensor. The computing system is configured to receive, from the first position sensor, data associated with a first position of the first position sensor; receive, from the second position sensor, data associated with a second position of the second position sensor; determine a speed difference between the first position sensor and the second position sensor; and extrapolate the speed difference to determine a nozzle characteristic based on the speed difference.

In some aspects, the present subject matter is directed to a method for an agricultural application operation. The method includes receiving, from a first position sensor, data associated with a first position of a first position sensor along a boom assembly. The method also includes receiving, from a second position sensor separated from the first position sensor, data associated with a second position of the second position sensor. The method further includes determining, with a computing system, a speed difference between the first position sensor and the second position sensor. Lastly, the method includes extrapolating, with the computing system, the speed difference to determine a nozzle assembly speed based on the speed difference and a defined position of the nozzle assembly along the boom assembly.

In some aspects, the present subject matter is directed to an agricultural system that includes a first position sensor positioned along a boom arm and a second position sensor separated from the first position. A computing system is communicatively coupled to the first position sensor and the second position sensor. The computing system is configured to receive, from the first position sensor, data associated with a first position of the first position sensor; receive, from the second position sensor, data associated with a second position of the second position sensor; and determine a boom deflection model based on the first position relative to the second position.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural work vehicle in accordance with aspects of the present subject matter;

FIG. 2 illustrates a side view of the work vehicle in accordance with aspects of the present subject matter;

FIG. 3 is an enhanced view of section III of FIG. 1 illustrating a rear view of a portion of a boom assembly in accordance with aspects of the present subject matter;

FIG. 4 is a top schematic view of a portion of a boom assembly in accordance with aspects of the present subject matter;

FIG. 5 illustrates a block diagram of components of the agricultural applicator system in accordance with aspects of the present subject matter; and

FIG. 6 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises... a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to an agricultural system that may include a boom assembly including a frame and a boom arm, a nozzle assembly positioned along the boom assembly, a first position sensor, and a second position sensor separated from the first position. A computing system is operably coupled with the first position sensor and the second position sensor. In some cases, the computing system may be configured to receive data associated with a first position of the first position sensor from the first position sensor. In addition, the computing system may be configured to receive data associated with a second position of the second position sensor from the second position sensor. In turn, the computing system may determine a speed difference between the first position sensor and the second position sensor. Further, the computing system may extrapolate the speed difference to determine a nozzle characteristic based on the speed difference. As provided herein, the nozzle characteristic can include a nozzle assembly speed, a nozzle assembly direction, an actual duty cycle of the nozzle assembly, a calculated duty cycle of the nozzle assembly, an acceleration of the nozzle assembly, a position of the nozzle assembly relative to its default position, a position of the nozzle assembly relative to the ground surface, an airflow vector associated with the nozzle assembly based on the nozzle assembly conditions, and/or any other characteristic.

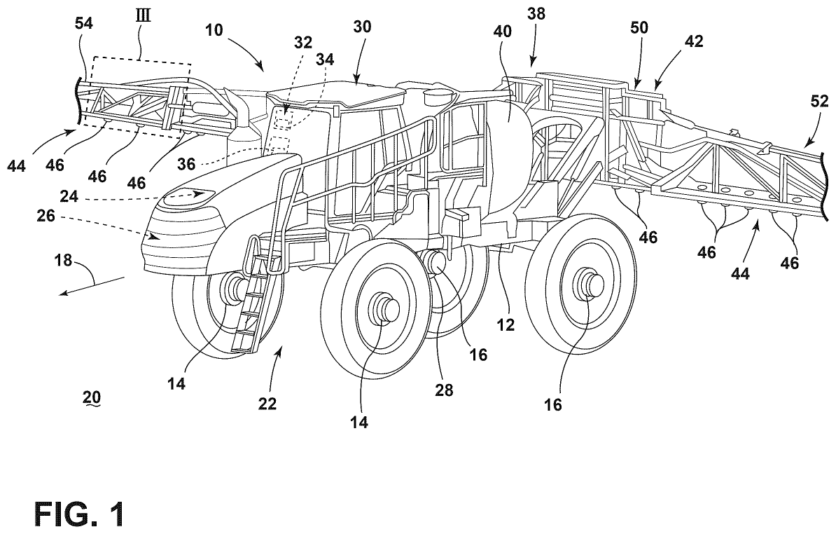

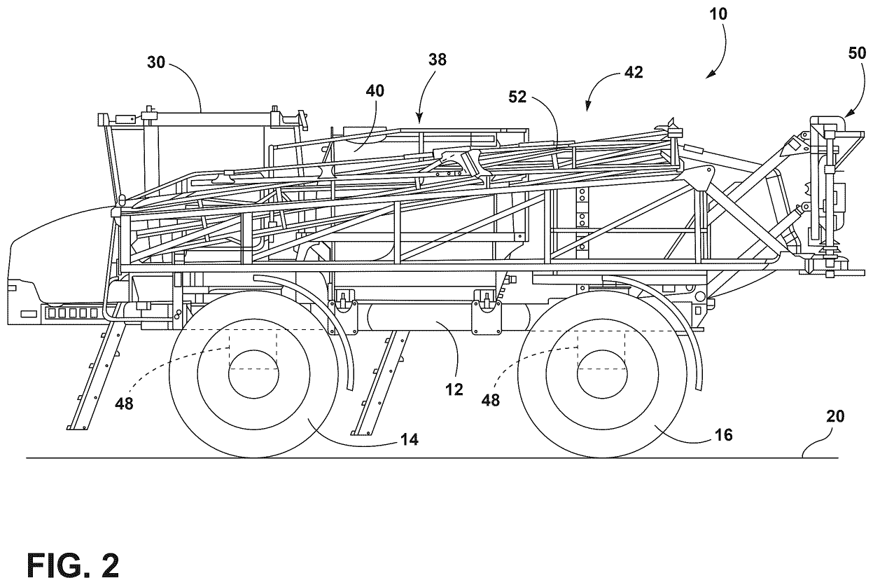

Referring now to FIGS. 1 and 2, a work vehicle 10 is generally illustrated as a self-propelled agricultural applicator. However, in alternate embodiments, the work vehicle 10 may be configured as any other suitable type of work vehicle 10 configured to perform agricultural application operations, such as a tractor or other vehicle configured to haul or tow an application implement.

In various embodiments, the work vehicle 10 may include a chassis 12 configured to support or couple to a plurality of components. For example, front and rear wheels 14, 16 may be coupled to the chassis 12. The wheels 14, 16 may be configured to support the work vehicle 10 relative to a ground surface 20 and move the work vehicle 10 in a direction of travel (e.g., as indicated by arrow 18 in FIG. 1) across the ground surface 20. In this regard, the work vehicle 10 may include a powertrain control system 22 that includes a power plant 24, such as an engine, a motor, or a hybrid engine-motor combination, a transmission or hydraulic propel system 26 configured to transmit power from the engine to the wheels 14, 16, and/or a brake system 28.

The chassis 12 may also support a cab 30, or any other form of user's station, for permitting the user to control the operation of the work vehicle 10. For instance, as shown in FIG. 1, the work vehicle 10 may include a user interface 32 having a display 34 for providing messages and/or alerts to the user and/or for allowing the user to interface with the vehicle's controller through one or more user input devices 36 (e.g., levers, pedals, control panels, buttons, and/or the like).

The chassis 12 may also support a product system 38 that includes one or more tanks 40, such as a rinse tank and/or a product tank, and a boom assembly 42 mounted to the chassis 12. The product tank is generally configured to store or hold an agricultural product, such as a pesticide, a fungicide, a rodenticide, a fertilizer, a nutrient, and/or the like. The agricultural product is conveyed from the product tank through plumbing components, such as interconnected pieces of tubing, for release onto the underlying ground surface 20 (e.g., plants and/or soil) through an application system 44 that may include one or more nozzle assemblies 46 mounted on the boom assembly 42. In some embodiments, to improve the agricultural product application quality and/or user comfort, the vehicle 10 may be equipped with a passive, semi-active, or active vehicle suspension 48 to dampen movement of the vehicle 10 and/or the boom assembly 42 while operating the vehicle 10 and/or the boom assembly 42.

As shown in FIGS. 1 and 2, the boom assembly 42 may include a frame 50 that supports first and second boom arms 52, 54, which may be orientated in a cantilevered nature. The first and second boom arms 52, 54 are generally movable between an operative or unfolded position (FIG. 1) and an inoperative or folded position (FIG. 2). When distributing the product, the first and/or second boom arm 52, 54 extends laterally outward from the work vehicle 10 to cover swaths of the underlying ground surface 20, as illustrated in FIG. 1. However, to facilitate transport, each boom arm 52, 54 of the boom assembly 42 may be independently folded forwardly or rearwardly into the inoperative position, thereby reducing the overall width of the vehicle 10, or in some examples, the overall width of a towable implement when the applicator is configured to be towed behind the work vehicle 10.

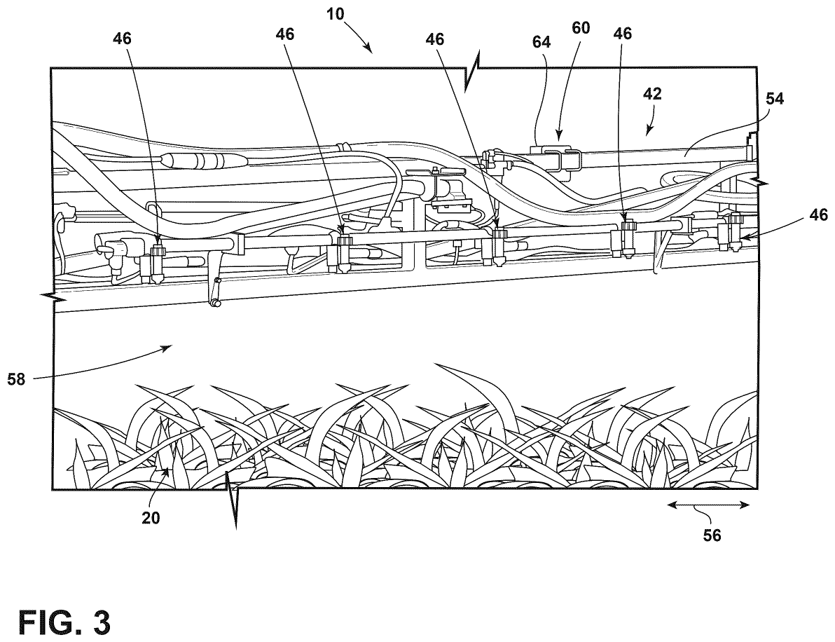

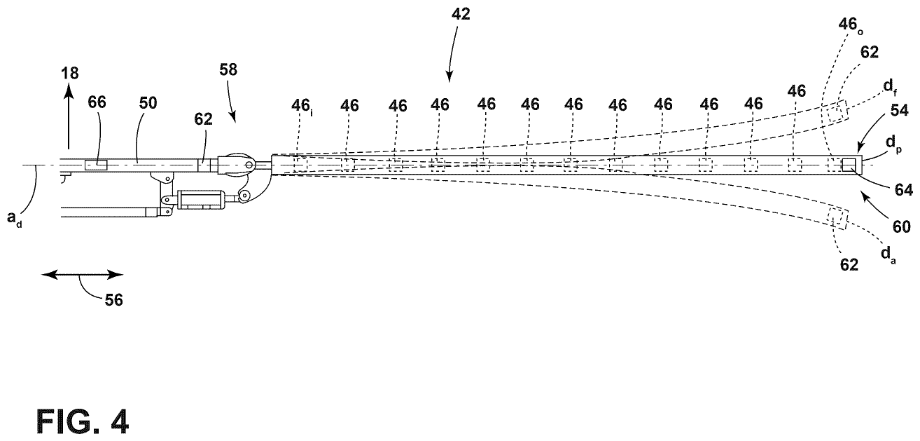

Referring to FIGS. 3 and 4, the boom assembly 42 may be configured to support a plurality of nozzle assemblies 46. Each nozzle assembly 46 may be configured to dispense an agricultural product stored within the tank 40 (FIG. 1) onto the underlying ground surface 20. In several embodiments, the nozzle assemblies 46 may be mounted on and/or coupled to the first and/or second boom arms 52, 54 of the boom assembly 42, with the nozzle assemblies 46 being spaced apart from each other along a lateral direction 56. Furthermore, conduits may fluidly couple the nozzle assemblies 46 to the tank 40. In this respect, as the work vehicle 10 travels across the ground surface 20 in the direction of travel 18 to perform an application operation, the agricultural product moves from the tank 40 through the conduit to each of the nozzle assemblies 46. The nozzle assemblies 46 may, in turn, dispense or otherwise spray a fan of the agricultural product onto the underlying ground surface 20. For example, the nozzle assemblies 46 may include flat fan nozzles configured to dispense a flat fan of the agricultural product. However, in alternative embodiments, the nozzle assemblies 46 may include any other suitable types of nozzles, such as dual pattern nozzles and/or hollow cone nozzles.

With further reference to FIGS. 3 and 4, during an application operation, various forces may be placed on the boom assembly 42 causing the boom assembly 42 and, consequently, the nozzle assemblies 46 positioned along the boom assembly 42, to be deflected or repositioned relative to the frame 50 and/or the work vehicle 10. For instance, a portion of the boom assembly 42 may be deflected from an assumed or a default position dₚ due to high dynamic forces encountered when the work vehicle 10 is turned, accelerated, or decelerated. In addition, terrain variations and weather variances may also cause deflection of the boom assembly 42. Further, a portion of the boom assembly 42 may come in contact with an object, thereby leading to deflection of the boom assembly 42.

In embodiments that utilize a boom arm 54 that is supported by the frame 50 in a cantilevered orientation, such as the one illustrated in FIG. 4 (or any other non-uniformly supported orientation), an outer nozzle assembly 46ₒ may have a greater deflection magnitude from its default position dₚ than an inner nozzle assembly 46ᵢ. Once the deflective force is overcome and/or no longer present, the boom arm 54 will move back towards its default position dₚ. In some embodiments, the movement of the boom arm 54 may generally occur as harmonic oscillations across the default axis a_{d} such that the boom arm 54 may move from a position at least partially aft of the default axis a_{d} to the default position dₚ and then to a position at least partially fore of the default position dₚ and so on. During the oscillations, an acceleration or speed of an inner nozzle assembly 46ᵢ may be less than the outer nozzle assembly 46ₒ due to the varied deflection magnitudes along the boom arm 54. In addition, once the boom assembly 42 is deflected, a path of movement of the inner nozzle assembly 46ᵢ may be non-parallel to a path of movement of the outer nozzle assembly 46ₒ.

In some instances, a boom deflection model may map a deflection of each nozzle assembly 46 from a default axis a_{d}, which may define one or more nozzle characteristics. In various embodiments, the boom deflection model may be determined through various geometric equations, lookup tables (LUTs), and/or any other method to determine a position, a speed, and/or an acceleration of each nozzle assembly 46.

In some embodiments, the boom deflection model may be based on data from a positioning system 60, which may include a first position sensor 62 and a second position sensor 64. In various instances, the first position sensor 62 may be positioned on the frame 50 of the boom assembly 42 and/or remotely from the boom assembly 42, such as the vehicle supporting the boom assembly 42. The second position sensor 64 may be operably coupled with the first boom arm 52 and/or the second boom arm 54.

In operation, the first position sensor 62 may move along a varied movement path from the second position sensor 64, due at least in part to the construction (e.g., cantilevered orientation) of the first boom arm 52 and the second boom arm 54 from the frame 50. As such, the position of the first position sensor 62 and the position of the second position sensor 64 may be used to determine the boom deflection model and/or a location of each nozzle assembly 46 along the boom assembly 42. Moreover, in some examples, a first distance may be defined between the deflected position of the first nozzle assembly 46 relative to a default position of the first nozzle assembly 46 and a second distance may be defined between the deflected position of the second nozzle assembly 46 relative the default position of the second nozzle assembly 46. The first distance may be varied from, or equal to, the second distance.

In various examples, an expected duty cycle for each nozzle control valve during application may also be calculated. As used herein, the expected duty cycle is defined as the duty cycle calculated based on the speed of each nozzle assembly 46 in a longitudinal direction (in the direction of travel 18), a lateral direction 56, and/or a vertical direction while the actual duty cycle is defined as the duty cycle gathered from the application system and/or any other source.

In various examples, each of the first position sensor 62 and the second position sensor 64 may be configured as Global Positioning System (GPS) receivers, or any other global navigation satellite system (GNSS), that provides geolocation and time information to each of the GPS receivers. In various cases, each of the GPS receivers may not require the user to transmit any data, and/or may operate independently of any telephone or Internet reception. As shown in FIGS. 3 and 4, the first position sensor 62 may be configured as a GNSS survey-grade base rover receiver that may be installed on the frame 50 of the boom assembly 42 and the second position sensor 64 may be configured as a dual-frequency GNSS receiver that may be installed along the first boom arm 52 and/or the second boom arm 54 in a defined position. Both GPS receivers may be configured to receive Real-time kinematic positioning (RTK) at any frequency (e.g., 10 hertz) to correct any errors in the current satellite navigation (GNSS) system. In some instances, the RTK may use measurements of the phase of the signal's carrier wave in addition to the information content of the signal and rely on a single reference station or interpolated virtual station to provide real-time corrections, providing up to centimeter-level accuracy to each GPS receiver. In examples that utilize a first position sensor 62 and a second position sensor 64, each of the nozzle assemblies 46 across the boom assembly 42 may be mapped using a geographic information system (GIS), thereby providing the ability to create, store, manage, query, analyze, and visualize data representing the position of each nozzle assembly 46 relative to one another and/or the underlying field (FIG. 3).

In various embodiments, a weather station 66 may be configured to capture data indicative of one or more weather criteria, such as temperature, wind speed, wind direction, relative humidity, barometric pressure, cloud cover, and trends thereof. With the position and the movement direction of each nozzle assembly 46 known and a wind direction at the defined position, a nozzle airflow vector may be generated for each nozzle assembly 46.

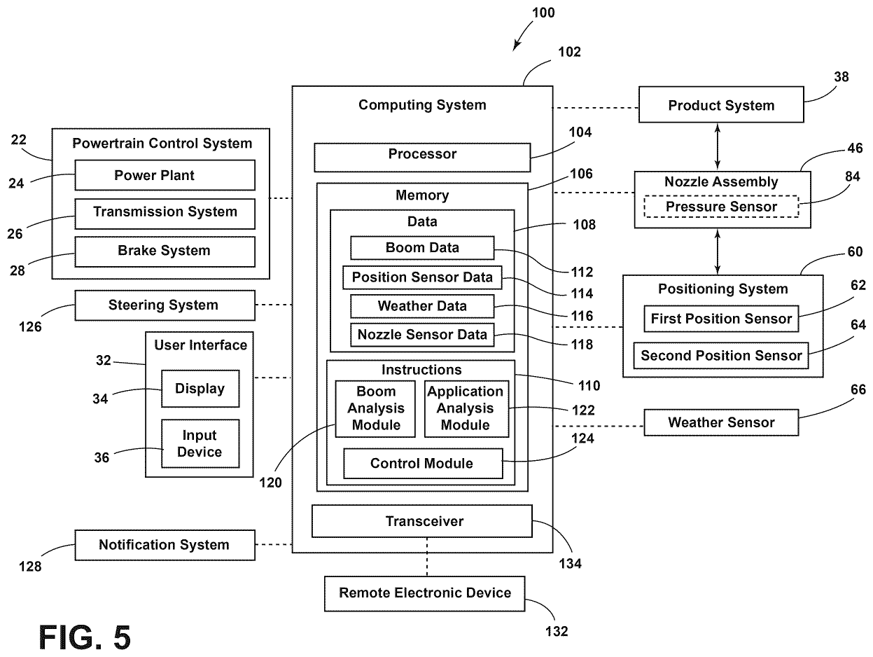

Referring now to FIG. 5, a schematic view of a system 100 for operating the work vehicle 10 is illustrated in accordance with aspects of the present subject matter. In general, the system 100 will be described with reference to the work vehicle 10 described above with reference to FIGS. 1-4. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 5 are indicated by dashed lines.

As shown in FIG. 5, the system 100 may include a computing system 102 operably coupled with the agricultural product application system 44 that may be configured to dispense an agricultural product from the product system 38 to the ground surface 20 (FIG. 1) through one or more nozzle assemblies 46 that may be positioned at least partially along the boom assembly 42 (FIG. 1). In several embodiments, the nozzle assemblies 46 may include a nozzle and a valve for activating the respective nozzle to perform a spray operation. The valves may include restrictive orifices, regulators, and/or the like to regulate the flow of agricultural product from the product system 38 that is emitted from each nozzle. In various embodiments, the valves may be configured as electronically controlled valves that are controlled by a Pulse Width Modulation (PWM) signal for altering the application rate of the agricultural product.

In some cases, the computing system 102 may be configured to receive data associated with a first position of the first position sensor 62 from the first position sensor 62. In addition, the computing system 102 may be configured to receive data associated with a second position of the second position sensor 64 from the second position sensor 64. In turn, the computing system 102 may determine a speed difference between the first position sensor 62 and the second position sensor 64. Further, the computing system 102 may extrapolate the speed difference to determine a nozzle characteristic based on the speed difference. As provided herein, the nozzle characteristic can include a nozzle assembly speed, a nozzle assembly direction, an actual duty cycle of the nozzle assembly 46, a calculated duty cycle of the nozzle assembly 46, an acceleration of the nozzle assembly 46, a position of the nozzle assembly 46 relative to its default position, a position of the nozzle assembly 46 relative to the ground surface 20 (FIG. 3), an airflow vector associated with the nozzle assembly 46 based on the nozzle assembly conditions, and/or any other characteristic.

In general, the computing system 102 may include any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data 108 that may be retrieved, manipulated, created, and/or stored by the processor 104 and instructions 110 that may be executed by the processor 104, when implemented by the processor 104, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

In various embodiments, the computing system 102 may correspond to an existing controller of the agricultural work vehicle 10, or the computing system 102 may correspond to a separate processing device. For instance, in some embodiments, the computing system 102 may form all or part of a separate plug-in module or computing device that is installed relative to the work vehicle 10 or the boom assembly 42 to allow for the disclosed system 100 and method to be implemented without requiring additional software to be uploaded onto existing control devices of the work vehicle 10 or the boom assembly 42.

In several embodiments, the data 108 may be information received and/or generated by the computing system 102 that is stored in one or more databases. For instance, as shown in FIG. 5, the memory 106 may include a boom database 112, which may be configured to store data and/or algorithms related to one or more boom assemblies that may be used by the system 100. For example, the boom database 112 may be configured to receive inputs related to and/or detect various boom characteristics, such as a length of the boom, a number of the nozzle assemblies 46 along the boom assembly 42, the position of the nozzle assemblies 46 along the boom assembly 42, and/or any other data. In addition, the boom database 112 may include various algorithms, LUTs, etc. that are associated with each boom based on the boom characteristics.

In addition, the memory 106 may include a position sensor database 114 for storing position data received from the first position sensor 62 and/or the second position sensor 64. For example, the position sensors 64 may be configured to continuously or periodically capture data associated with its position, which in turn, may be indicative of a boom deflection position. In such embodiments, the data transmitted to the computing system 102 from the position sensors 64 may be stored within the position sensor database 114 for subsequent processing and/or analysis.

The memory 106 may also include a weather database 116 for storing weather data that may be received from the weather station 66. The weather data may include at least a wind speed and/or a direction in a defined position. In such embodiments, the data transmitted to the computing system 102 from the weather station 66 may be stored within the weather database 116 for subsequent processing and/or analysis.

The memory 106 may further include a nozzle sensor database 118 for storing data received from the one or more nozzle sensors. For example, the nozzle sensors may include a pressure sensor 84 that may be configured to continuously or periodically capture data associated with a pressure within the one or more nozzle assemblies 46. In such embodiments, the data transmitted to the computing system 102 from the nozzle sensors may be stored within the nozzle sensor database 118 for subsequent processing and/or analysis. In addition, in some instances, the nozzle sensor database 118 may also store data related to one or more variables that may affect a spray quality index.

In several embodiments, the instructions 110 stored within the memory 106 of the computing system 102 may be executed by the processor 104 to implement a boom analysis module 120, an application analysis module 122, and/or a control module 124.

In general, the boom analysis module 120 may be configured to process/analyze the data 112 to determine a position of each of the nozzle assemblies 46 based on the boom data and/or the position data to determine the actual positions of the nozzle assemblies 46 along the boom assembly 42. In some cases, the boom analysis module 120 may determine a speed difference between the first position sensor 62 and the second position sensor 64. Moreover, the speed difference may be divided by the number/location of nozzle assemblies 46 between the first position sensor 62 and the second position sensor 64 (and/or correlated to the position of each nozzle assembly 46 in any other manner). The calculated difference may be added or subtracted to each nozzle assembly 46, depending on the direction and speed of the vehicle 10 (e.g., whether the vehicle 10 is turning and, if so, which direction and radius of curvature), starting from the center boom section, and then extrapolated to the outer nozzle assemblies 46 along the boom assembly 42 to calculate an actual characteristic of each nozzle assembly 46.

In addition, the boom analysis module 120 may calculate a duty cycle accuracy by using an expected duty cycle and an actual duty cycle. In some cases, pressure data provided by the pressure sensor 84 (e.g., a pressure transducer), which may be installed in one or more nozzle assemblies 46 across the boom assembly 42 (or in any other practicable location), the nozzle speed, and the nozzle spacing may be used to determine a nozzle flow rate. In turn, a nozzle spray index may be calculated using a percent difference between the actual application rate and the target application rate. The duty cycle and the nozzle spray index may both be used to provide additional information to the operator regarding the performance of the application operation.

With further reference to FIG. 5, the application analysis module 122 may be configured to analyze the initial or raw sensor data captured by the nozzle sensor, the first position sensor 62, the second position sensor 64, the nozzle spray index, and/or the weather station 66 to allow the computing system 102 to estimate the spray quality index of one or more sections of the ground surface 20. For instance, the application analysis module 122 may be configured to execute one or more suitable data processing techniques or algorithms that allow the computing system 102 to accurately and efficiently analyze the sensor data, such as by applying corrections or adjustments to the data based on the sensor type, sensor resolution, and/or other parameters associated with the sensors 82, the first position sensor 62, the second position sensor 64, the data determined by the boom analysis module, and/or the weather station 66, by filtering the data to remove outliers, by implementing sub-routines or intermediate calculations to estimate the spray quality index based on the one or more application variables, and/or by performing any other desired data processing-related techniques or algorithms.

The active control module 124 may provide instructions for various components communicatively coupled with the computing system 102 based on the results of the boom analysis module 120 and/or the application analysis module 122. For example, the active control module 124 may provide notifications and/or instructions to the user interface 32, a vehicle notification system 128, and/or a remote electronic device 132. In some examples, the display 34 of the user interface 32 may be capable of displaying information related to the airflow vectors of each respective nozzle assembly 46.

The active control module 124 may also be capable of altering a system or component of the vehicle 10 in response to the spray quality index varying from a defined range. For instance, in some embodiments, the computing system 102 may adjust an agricultural product application system 44 by altering a flow rate of one or more nozzle assemblies 46 based at least in part on the airflow vector associated with the one or more nozzle assemblies 46. Additionally, or alternatively, in some examples, the active control module 124 may alter the operation of the application system 44 to pause or otherwise change the application of the agricultural product in response to determining that a threshold number of airflow vectors exceeds a defined range.

In addition, various other components may be adjusted by the active control module 124 in response to one or more application variables deviating from a defined range or threshold. For example, the computing system 102 may also adjust or alter the powertrain control system 22, the steering system 126, and/or the vehicle suspension 48 when the spray quality index deviates from a defined range.

In some embodiments, the vehicle notification system 128 may prompt visual, auditory, and tactile notifications and/or warnings when one or more airflow vectors exceeds a defined range of magnitudes or directions, the spray quality index deviates from a predefined range, and/or one or more functions of the vehicle 10 or the boom assembly 42 is altered by the computing system 102. For instance, vehicle brake lights and/or vehicle emergency flashers may provide a visual alert. A vehicle horn and/or speaker may provide an audible alert. A haptic device integrated into the cab 30 and/or any other location may provide a tactile alert. Additionally, the computing system 102 and/or the vehicle notification system 128 may communicate with the user interface 32 of the vehicle 10.

In addition to providing the notification to the user, the computing system 102 may additionally store the location of the vehicle 10 at the time of the notification, which may be determined through the positioning system 60. The stored location may be displayed through a field map to illustrate locations of the field in which an agricultural product may have been applied within a defined range and/or misapplied by deviating from the defined range.

Further, the computing system 102 may communicate via wired and/or wireless communication with one or more remote electronic devices 132 through a transceiver 134. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 132 may also include a display for displaying information to a user. For instance, the electronic device 132 may display one or more user interfaces and may be capable of receiving remote user inputs to set a predefined threshold for any of the application variables and/or to input any other information, such as the agricultural product to be used in a spray operation. In addition, the electronic device 132 may provide feedback information, such as visual, audible, and tactile alerts, and/or allow the user to alter or adjust one or more components of the vehicle 10 or the boom assembly 42 through the usage of the remote electronic device 132. It will be appreciated that the electronic device 132 may be any one of a variety of computing devices and may include a processor and memory. For example, the electronic device 132 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

Although the various control functions and/or actions are generally described herein as being executed by the computing system 102, one or more of such control functions/actions (or portions thereof) may be executed by a separate computing system 102 or may be distributed across two or more computing systems (including, for example, the computing system 102 and a separate computing system). For instance, in some embodiments, the computing system 102 may be configured to acquire data from the nozzle sensors and/or the position sensors 64 for subsequent processing and/or analysis by a separate computing system (e.g., a computing system associated with a remote server). In other embodiments, the computing system 102 may be configured to execute the boom analysis module 120 and/or the application analysis module 122, while a separate computing system (e.g., a computing system associated with the agricultural work vehicle 10) may be configured to execute the control module 124 to control the operation of the agricultural work vehicle 10 based on data and/or instructions transmitted from the computing system 102 that are associated with the monitored objects and/or field conditions. Likewise, in some embodiments, the computing system 102 may be configured to acquire data from the nozzle sensors and/or the position sensors 64 for subsequent processing and/or analysis by a separate computing system (e.g., a computing system associated with a remote server). In other embodiments, the computing system 102 may be configured to execute the boom analysis module 120 to determine a nozzle airflow vector for one or more nozzle assemblies 46, while a separate computing system (e.g., a computing system associated with the agricultural work vehicle 10) may be configured to execute the control module 124 to control the operation of the agricultural work vehicle 10 based on data and/or instructions transmitted from the computing system 102 that are associated with the boom deflection model.

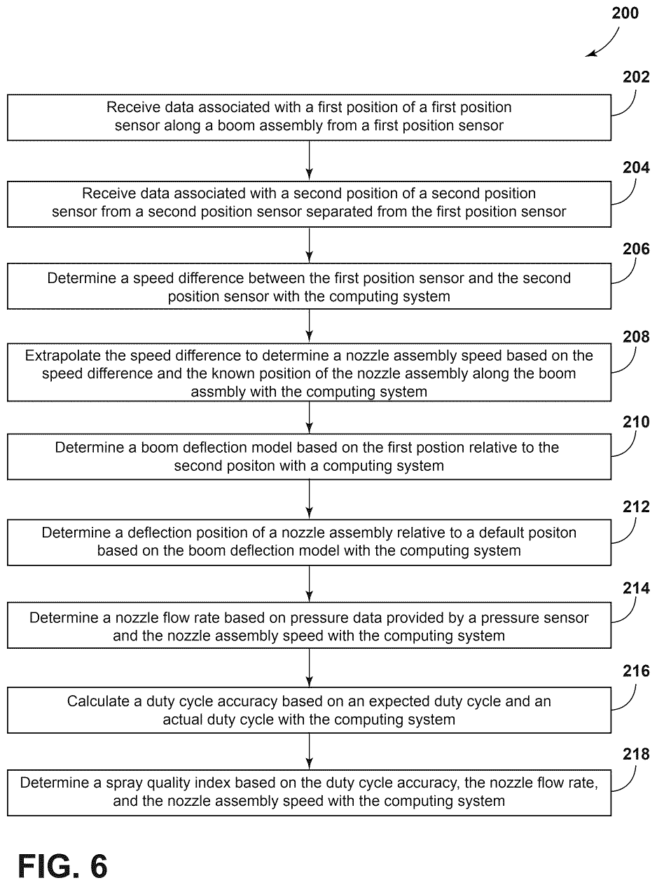

Referring now to FIG. 6, a flow diagram of some embodiments of a method 200 for operating an agricultural applicator is illustrated in accordance with aspects of the present subject matter. In general, the method 200 will be described herein with reference to the work vehicle 10 and the system 100 described above with reference to FIGS. 1-5. However, the disclosed method 200 may generally be utilized with any suitable agricultural work vehicle 10 and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As shown in FIG. 6, at (202), the method 200 may include receiving data associated with a first position of a first position sensor along a boom assembly from a first position sensor. At (204), the method 200 may include receiving data associated with a second position of the second position sensor from a second position sensor separated from the first position sensor.

At (206), the method 200 may include determining a speed difference between the first position sensor and the second position sensor with the computing system. As provided herein, the first position sensor may be configured as a GNSS survey-grade base rover receiver that may be installed on the frame of the boom assembly and the second position sensor may be configured as a dual-frequency GNSS receiver that may be installed along the first boom arm or the second boom arm in a defined position. Both GPS receivers may be configured to receive Real-time kinematic positioning (RTK) at any frequency (e.g., 10 hertz) to correct any errors in the current satellite navigation (GNSS) system. In some instances, the RTK may use measurements of the phase of the signal's carrier wave in addition to the information content of the signal and rely on a single reference station or interpolated virtual station to provide real-time corrections, providing up to centimeter-level accuracy to each GPS receiver.

At (208), the method 200 may include extrapolating the speed difference to determine a nozzle assembly speed based on the speed difference and the defined position of the nozzle assembly along the boom assembly with the computing system.

In some cases, at (210), the method 200 may include determining a boom deflection model based on the first position relative to the second position with a computing system. At (212), the method 200 may include determining a deflected position (or any other actual characteristic) of a nozzle assembly relative to a default position (or any other default characteristic) based on the boom deflection model with the computing system.

At (214), the method 200 may include determining a nozzle flow rate based on pressure data provided by a pressure sensor and the nozzle assembly speed with the computing system. At (216), the method 200 may include calculating a duty cycle accuracy based on an expected duty cycle and an actual duty cycle with the computing system.

At (218), the method 200 may include determining a spray quality index based on the duty cycle accuracy, the nozzle flow rate, and the nozzle assembly speed with the computing system. In some instances, the spray quality index may be used to determine whether the agricultural product was applied to various portions of the ground surface 20 within a defined range and/or misapplied to various portions of the ground surface 20 by deviating from the defined range. In several embodiments, the one or more spray quality parameters that may affect the spray quality may include at least one of an airflow at each nozzle assembly 46, a nozzle tip size and style, which agricultural product is being applied, an incorrect agricultural product application rate, inclement weather as determined by meeting one or more criteria, an agricultural product application rate or pressure deviating from a predefined range, boom assembly deflection/movement (e.g., jounce) deviating from a movement range, a vehicle deviating from a predefined speed, a vehicle acceleration/deceleration deviating from a predefined range, a turning radius deviating from predefined criteria, and/or any other variable.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the boom deflection model. In some instances, the vehicle learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a boom assembly including a frame and a boom arm;
a nozzle assembly positioned along the boom assembly;
a first position sensor;
a second position sensor separated from the first position; and
a computing system communicatively coupled to the first position sensor and the second position sensor, the computing system being configured to:
receive, from the first position sensor, data associated with a first position of the first position sensor;
receive, from the second position sensor, data associated with a second position of the second position sensor;
determine a speed difference between the first position sensor and the second position sensor; and
extrapolate the speed difference to determine a nozzle characteristic based on the speed difference.

2. The system of claim 1, wherein the first position sensor is configured as a GNSS survey-grade base rover receiver and the second position is configured as a dual-frequency GNSS receiver.

3. The system of claim 1, wherein the first position sensor is positioned on the frame of the boom assembly and the second position sensor is positioned along a boom arm of the boom assembly.

4. The system of claim 1, wherein the first position sensor is positioned remotely from the boom assembly and the second position sensor is positioned along a boom arm of the boom assembly.

5. The system of claim 4, further comprising:
a weather station configured to provide data indicative of one or more weather criteria.

6. The system of claim 1, wherein the second position sensor is operably coupled with a frame of the boom assembly.

7. The system of claim 1, wherein the second position sensor is operably coupled with a vehicle supporting the boom assembly.

8. The system of claim 1, further comprising:
a second nozzle assembly positioned along the boom assembly and configured to selectively dispense an agricultural product therefrom, wherein the computing system communicatively coupled to the second nozzle assembly and is further configured to determine a deflected position of the second nozzle assembly relative to a default position of the second nozzle assembly based on a boom deflection model.

9. The system of claim 8, wherein a first distance is defined between the deflected position of the first nozzle assembly relative to the default position of the first nozzle assembly and a second distance is defined between the deflected position of the second nozzle assembly relative the default position of the second nozzle assembly, and wherein the first distance is varied from the second distance.

10. A method for an agricultural application operation, the method comprising:
receiving, from a first position sensor, data associated with a first position of a first position sensor along a boom assembly;
receiving, from a second position sensor separated from the first position sensor, data associated with a second position of the second position sensor;
determining, with a computing system, a speed difference between the first position sensor and the second position sensor; and
extrapolating, with the computing system, the speed difference to determine a nozzle assembly speed based on the speed difference and a defined position of the nozzle assembly along the boom assembly.

11. The method of claim 10, further comprising:
determining, with a computing system, a boom deflection model based on the first position relative to the second position.

12. The method of claim 11, further comprising:
determining, with the computing system, a deflected position of a nozzle assembly relative to a default position based on the boom deflection model.

13. The method of claim 12, further comprising:
determining, with the computing system, a nozzle flow rate based on pressure data provided by a pressure sensor and the nozzle assembly speed.

14. The method of claim 13, further comprising:
calculating, with the computing system, a duty cycle accuracy based on an expected duty cycle and an actual duty cycle.

15. The method of claim 14, further comprising:
determining, with the computing system, a spray quality index based on the duty cycle accuracy, the nozzle flow rate, and the nozzle assembly speed.

16. An agricultural system comprising:
a first position sensor positioned along a boom arm;
a second position sensor separated from the first position; and
a computing system communicatively coupled to the first position sensor and the second position sensor, the computing system being configured to:
receive, from the first position sensor, data associated with a first position of the first position sensor;
receive, from the second position sensor, data associated with a second position of the second position sensor; and
determine a boom deflection model based on the first position relative to the second position.

17. The system of claim 16, further comprising:
a boom assembly including a frame and the boom arm; and
a nozzle assembly positioned along the boom assembly.

18. The system of claim 17, wherein the computing system is further configured to:
determine a deflected position of the nozzle assembly relative to a default position based on the boom deflection model.

19. The system of claim 17, wherein the second position sensor is operably coupled with a frame of the boom assembly.

20. The system of claim 17, wherein the second position sensor is operably coupled with a vehicle supporting the boom assembly.
